(19) United States
(12) Patent Application Publication
(10) Pub. No.: US 2016/0322183 A1
(43) Pub. Date: Nov. 3, 2016

(54) DEVICE SWITCH FOR POWER TOOLS INCLUDING A SWITCH LOCKING MECHANISM

(71) Applicant: HILTI AKTIENGESSELLSCHAFT, Schaan (LI)

(72) Inventor: Andreas Vogel, Aschaffenburg (DE)

(21) Appl. No.: 15/104,497

(22) PCT Filed: Dec. 12, 2014
(86) PCT No.: PCT/EP2014/077537

§ 371 Date: Jun. 14, 2016

(30) Foreign Application Priority Data
Dec. 16, 2013 (EP) EP13197454.5

(51) Int. Cl. H01H 21/22

(52) U.S. Cl. CPC H01H 21/22

(57) ABSTRACT

Switch apparatus (1) for switching on and off a power tool, including a pushbutton element (10), which is pivotable reversibly about a pivot point (S) between a switch-on position and a switch-off position, wherein in the switch-on position the machine tool is switched on and in the switch-off position the machine tool is switched off; and a locking device (30) for releasably locking the pushbutton element (10) in the switch-on position. The locking device (30) includes a stop element (38) and the pushbutton element (10) includes a counter-stop element (40), wherein the stop element (38) is movable reversibly between a locking position, in which the stop element (38) bears against the counter-stop element (40) and the pushbutton element (10) is held in the switch-on position, and a release position, in which the pushbutton element (10) is returnable to the switch-off position.

The present invention relates to a switching device for switching a power tool on and off, including a pusher element, which is reversibly pivotable about a pivot point between a switch-on position and a switch-off position, where the power tool is switched on in the switch-on position and the power tool is switched off in the switch-off position; and a locking mechanism for releasably locking the pusher element in the switch-on position.

### BACKGROUND

Such switching devices are widely known and are utilized primarily for electric power tools including an electric motor, such as, for example, drills, grinders, saws, planers, angle grinders, and the like. The power tool may be a battery-operated and/or mains-operated power tool.

An electric switch including a housing for a power tool is known from DE 24 10 871 A1. A contact system is located in the housing. An actuating element situated on the housing is movable between a starting position and an end position. In the end position, the actuating element acts upon the contact system in a switching manner. The switch may be provided with a switch-on lock for the actuating element in the starting position and/or with a catch for the actuating element in the end position. The switch-on lock and/or the catch include/includes an actuating element and each also includes a blocking element, which interacts with the actuating element and may be situated on the housing.

In addition, an electric switch is also shown from EP 2 101 340 A1, which is suitable for use in a hand-held power tool including an electric motor. For this purpose, the switch includes a housing in which a contact system is located. An actuating element for acting on the contact system in a switching manner, which is movable between a starting position and an end position, is situated on the housing. The switch may optionally be provided with a switch-on lock and/or a catch for the actuating element, the switch-on lock and/or the catch including an actuating element and a blocking element interacting with the actuating element. The blocking element is situated on the housing in such a way that, when the actuating element moves into the end position, the blocking element plunges into a recess in the actuating element. In addition, the blocking element is designed in such a way that an optional interaction with the actuating element for either the switch-on lock and/or for the catch is made possible.

The above-described switching devices from the prior art are often designed to be highly complex and bulky, so that, due to spatial limitations, either only a locking mechanism, which holds the switching element in a switch-on mode, or only a transport safety device, which blocks the switching element when the power tool is transported, may be implemented in the particular switching device. A switching device into which both a locking mechanism and a transport safety device may be integrated is therefore possible only if the entire switching device is substantially enlarged.

In addition, the switching devices from the prior art also frequently have the problem that the locking mechanism may come loose in the presence of strong vibrations of the type that may occur during the use of the power tool, and the power tool unintentionally switches off again.

### SUMMARY OF THE INVENTION

It is an object of the present invention to provide an improved switching device for switching a power tool on and off, which eliminates the above-described problems and, in particular, includes a space-saving and vibration-resistant locking mechanism.

The present invention provides a switching device for switching a power tool on and off, including a pusher element, which is reversibly pivotable about a pivot point between a switch-on position and a switch-off position, where the power tool is switched on in the switch-on position and the power tool is switched off in the switch-off position; and a locking mechanism for releasably locking the pusher element in the switch-on position.

According to the present invention, it is provided that the locking mechanism includes a stop element and the pusher element includes a counter-stop element, where the stop element is reversibly movable between a locking position, in which the stop element rests against the counter-stop element and the pusher element is held in the switch-on position, and a release position, in which the pusher element is returnable to the switch-off position. As a result, a space-saving locking mechanism is achieved, due to which sufficient space for a transport safety device remains in the switching device.

According to a further advantageous embodiment of the present invention, it may be provided that the stop element has a chamfered stop surface and the counter-stop element has a counter-stop surface corresponding to the chamfered stop surface. Due to the stop surface and the counter-stop surface corresponding thereto, a release of the locking mechanism caused by high vibrations during the use of the power tool may be effectively prevented.

### BRIEF DESCRIPTION OF THE DRAWINGS

The present invention is described in greater detail with respect to advantageous exemplary embodiments.

FIG. 1 shows a side view of a power tool including a measuring device according to the present invention for measuring an operating time of a power tool; and

FIG. 2 shows a diagram of the measuring device according to the present invention,

FIG. 3 shows a diagram of the measuring device according to the present invention,

FIG. 4 shows a diagram of the measuring device according to the present invention; and

FIG. 5 shows a diagram of the measuring device according to the present invention.

### DETAILED DESCRIPTION

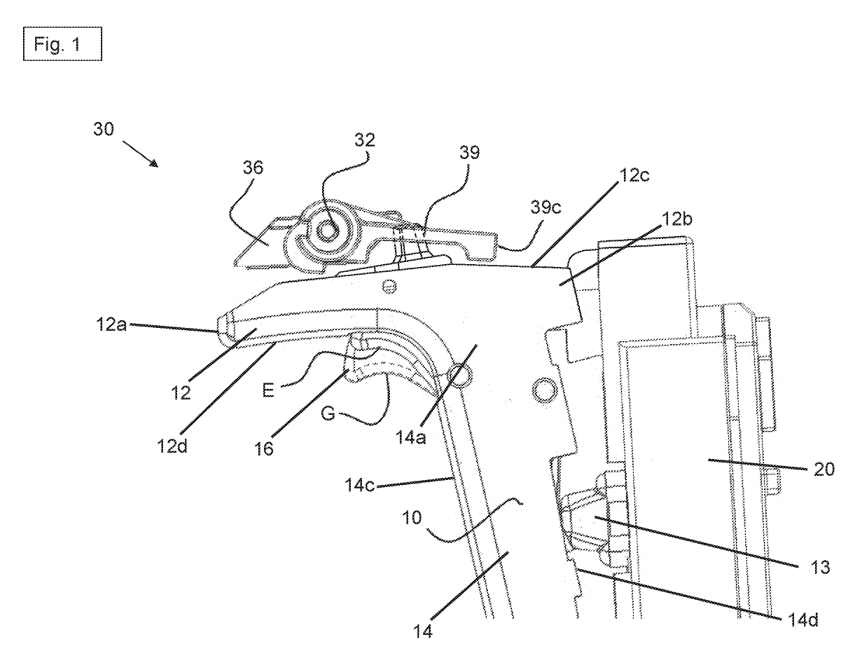

FIGS. 1 through 5 show a switching device 1 according to the present invention for switching a power tool on and off. The power tool is, for example, a drill, a percussion drill, a grinder, a saw, a planer, an angle grinder, or the like, including an electric motor.

Switching device 1 essentially includes a pusher element 10, a switch housing 20, and a locking mechanism 30.

Pusher element 10, in turn, includes an L-shaped switching element 11, a compression spring 15, and an unlocking switch 16. L-shaped switching element 11 is formed from a first (short) portion 12 and a second (long) portion 14.

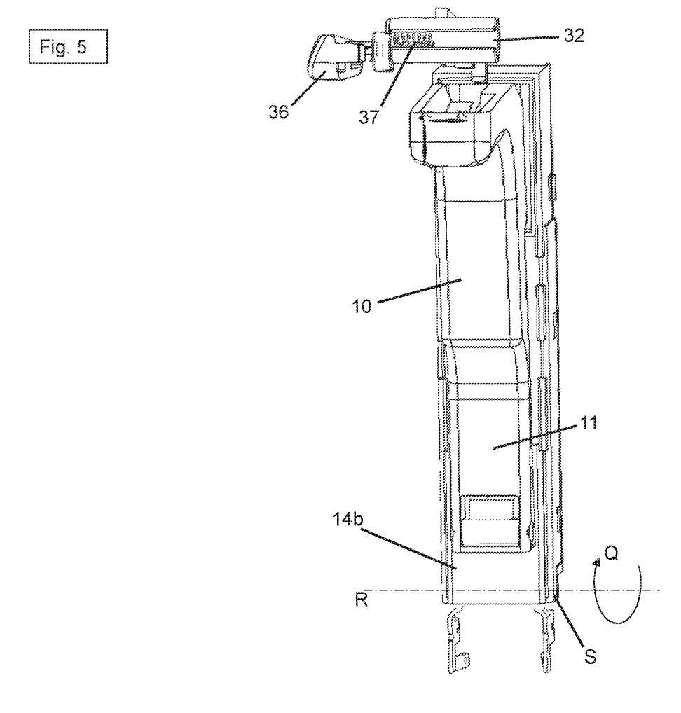

First portion 12 includes a first end 12a, a second end 12b, a first surface 12c, and a second surface 12d. Second portion 14 likewise includes a first end 14a, a second end 14b, a first surface 14c, and a second surface 14d. First surface 14c of second portion 14 is utilized, in particular, as the bearing surface for the fingers (not shown) of a user who intends to press pusher element 10 in order to switch on the power tool. Second surface 14d of second portion 14 includes a contact element (not shown), with the aid of which a counter-contact element 13 on switch housing 20 may be actuated when pusher element 10 is pivoted relative to switch housing 20. Second end 12b of first portion 12 is fixedly connected to first end 14a of second portion 14. Second end 14b of second portion 14 has a pivot point S on pivot axis R, about which switching element 11 may be pivoted (see also FIG. 5). Switching element 11 is pivotably connected to switch housing 20 via pivot point S. The pivoting about pivot point S is utilized for reversibly moving switching element 11 between a switch-off position and a switch-on position and relative to switch housing 20 and also relative to locking mechanism 30.

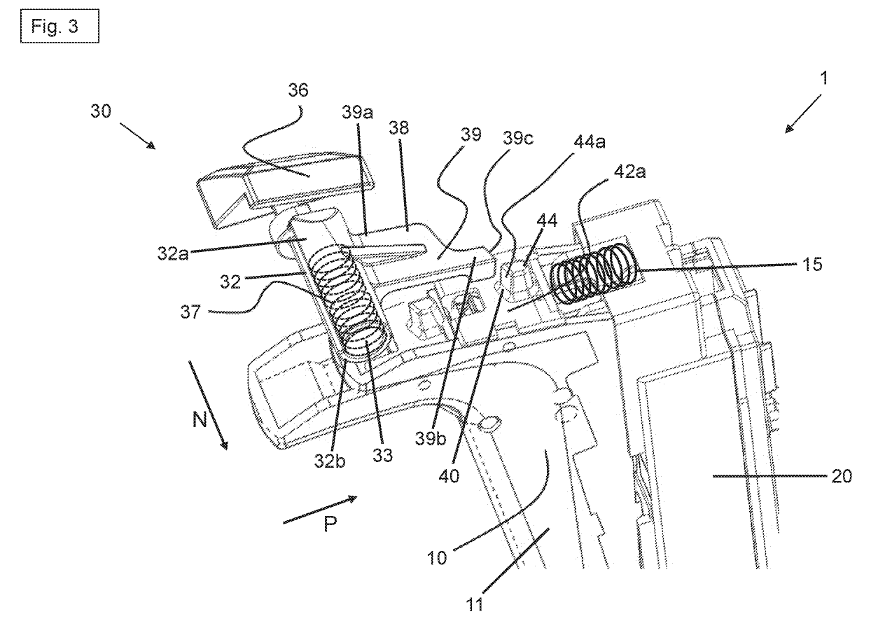

As represented in FIG. 3, compression spring 15 is positioned on first portion 12 of switching element 11 and is therefore located between switching element 11 and switch housing 20. Compression spring 15 is utilized for automatically returning pusher element 10 or switching element 11 from the switch-on position into the switch-off position.

Unlocking switch 16 is utilized as a transport safety device and ensures that pusher element 10 cannot be pivoted and the power tool cannot be started when this transport safety device is not pressed. Unlocking switch 16 is located, pivotably mounted, on first surface 14c of second portion 14 between first portion 12 and second portion 14 of switching element 11. FIG. 1 shows unlocking switch 16 in a first position G (dashed line), in which unlocking switch 16 is not actuated and pusher element 10 is blocked, and in a second position E (solid line), in which unlocking switch 16 is actuated and pusher element 10 is no longer blocked.

Locking mechanism 30 essentially includes a cylindrical base body 32, an actuating switch 36, a stop element 38, and a counter-stop element 40.

As shown in FIG. 3, cylindrical base body 32 has a first end 32a, a second end 32b, and a cylindrical hollow space 33. Actuating switch 36 is positioned on first end 32a of cylindrical base body 32. A compression coil spring 37 is located in hollow space 33.

Stop element 38 includes an elongate base body 39 having a first end 39a and a second end 39b. Stop element 38 is positioned via first end 39a of elongate base body 39 at the lateral surface of cylindrical base body 32 in such a way that this stop element 38 extends at a right angle (extending in direction P) with respect to cylindrical base body 32. A stop surface 39c which is chamfered, i.e., rising in direction N, is located on second (free) end 39b of elongate base body 39.

Cylindrical base body 32, actuating switch 36, and stop element 38 are attached on a housing (not shown) of the power tool (also not shown). Pusher element 10 may therefore be pivoted relative to cylindrical base body 32, actuating switch 36, and, in particular, relative to stop element 38.

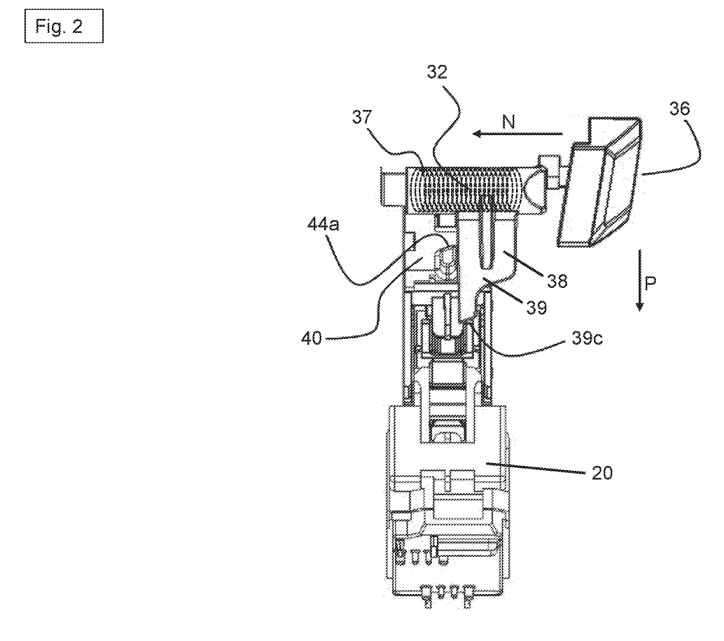

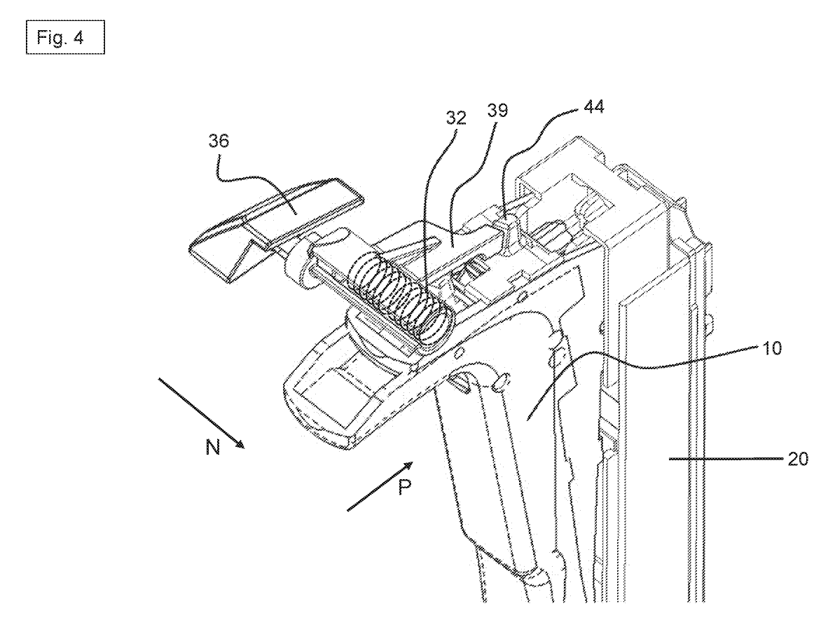

In addition, cylindrical base body 32, actuating switch 36, and stop element 38 may be reversibly moved between a locking position (as shown in FIG. 4) and a release position (as shown in FIGS. 1, 2, 3). Compression coil spring 37 is utilized for allowing cylindrical base body 32, actuating switch 36, and stop element 38 to be automatically returned from the locking position into the release position without actuation of actuating switch 36. As described in greater detail in the following, the locking position is utilized for holding pusher element 10 in the switch-on position. In the release position of locking mechanism 30, pusher element 10 may be returned to the switch-off position (see also FIGS. 1 and 2).

Counter-stop element 40 essentially includes a right-angled base body 42 having a top side 42a and an underside (not shown). A cylindrical pin 44 having a chamfered counter-stop surface 44a is positioned on top side 42a. Counter-stop surface 44a extends downward in direction N and therefore corresponds to stop surface 39c of stop element 38. Counter-stop element 40 is positioned on top side 12c of first portion 12 of L-shaped switching element 11, whereby counter-stop element 40 may be moved relative to cylindrical base body 32, actuating switch 36, and stop element 38 (as a result of the pivot motion of pusher element 10 in direction Q)

By pressing unlocking switch 16, the blockade of pusher element 10 is released and pusher element 10 may be pivoted about pivot axis R in direction Q.

As a result of the pivoting of pusher element 10, switching element 11 is also moved, so that this switching element is moved in direction P from the switch-off position into the switch-on position and, therefore, relative to switch housing 20. Since counter-stop element 40 is fixedly connected to first portion 12 of switching element 11, this counter-stop element is likewise moved with pusher element 10 into the switch-on position and, therefore, in direction P (see also FIG. 3). As a result, the contact element (not shown) positioned on second surface 14d of second portion 14 of switching element 11 is pressed against counter-contact element 13 on switch housing 20, whereby the power tool is switched on. In this case, the power tool remains switched on for as long as the contact element is pressed against counter-contact element 13. When pressure is no longer applied onto pusher element 10, this pusher element pivots from the switch-on position back into the switch-off position and, therefore, the power tool is switched off.

Pusher element 10 may be held in the switch-on position with the aid of locking mechanism 30 without the need for the user to continue applying pressure onto pusher element 10.

For this purpose, pressure is applied onto actuating switch 36, so that this actuating switch is moved in direction N and against compression coil spring 37. Cylindrical base body 32, actuating switch 36, and stop element 38 move in direction N into the locking position. In order to finally hold pusher element 10 in the switch-on position, counter-stop surface 44a of counter-stop element 40 and stop surface 39c of stop element 38 are pressed against one another, against the pressure of compression spring 15. Given that compression spring 15 is substantially stronger than compression coil spring 37 and, in particular, due to chamfered stop surface 39c and counter-stop surface 44a corresponding thereto, stop surface 39c and counter-stop surface 44a remain in contact with one another (see also FIG. 4). Consequently, due to locking mechanism 30, pusher element 10 remains in the switch-on position and the power tool therefore remains switched on despite strong vibrations.

In order to release the locking, i.e., the fixed setting of pusher element 10, again and therefore enable pusher element 10 to move from the (blocked) switch-on position back into the switch-off position, pressure is initially applied onto switching element 11 in order to move pusher element 10 in direction P. Due to this movement in direction P, stop surface 39c and counter-stop surface 44a corresponding thereto are moved apart from one another again, so that a certain gap forms between the two surfaces 39c, 44a. As soon as the gap forms between the two surfaces 39c, 44a, cylindrical base body 32, actuating switch 36, stop element 38 move under the pressure of compression coil spring 37 in cylindrical base body 32 from the locking position (as shown in FIG. 4) into the release position (as shown in FIGS. 1, 2, 3). For this purpose, elongate base body 39 is moved against direction N so far that counter-stop element 40 may move laterally past elongate base body 39 (see also FIGS. 1 and 2). Therefore, pusher element 10 may be pivoted back from the switch-on position into the switch-off position and the contact element no longer presses against counter-contact element 13, whereby the power tool is switched off.

1-2. (canceled)

3. A switching device for switching a power tool on and off, the switching device comprising:
a pusher reversibly pivotable about a pivot point between a switch-on position and a switch-off position, where the power tool is switched on in the switch-on position and the power tool is switched off in the switch-off position; and
a lock for releasably locking the pusher element in the switch-on position, the lock including a stop and the pusher including a counter-stop, where the stop is reversibly movable between a locking position, the stop resting against the counter-stop and the pusher being held in the switch-on position in the locking position, and a release position, the pusher returnable to the switch-off position in the release position.

4. The switching device as recited in claim 3 wherein the stop has a chamfered stop surface and the counter-stop has a counter-stop surface corresponding to the chamfered stop surface.
